(19) United States
(12) Patent Application Publication
(10) Pub. No.: US 2014/0068727 A1
(43) Pub. Date: Mar. 6, 2014

(54) WI-FI CREDENTIAL SHARING USING IMAGES

(71) Applicant: APPLE INC., Cupertino, CA (US)

(72) Inventors: Artiom Shamis, Los Gatos, CA (US); Kapil Chhabra, Milpitas, CA (US); Tito Thomas, San Jose, CA (US)

(73) Assignee: APPLE INC., Cupertino, CA (US)

(21) Appl. No.: 13/628,327

(22) Filed: Sep. 27, 2012

Related U.S. Application Data
(60) Provisional application No. 61/697,160, filed on Sep. 5, 2012.

(51) Int. Cl. H04W 12/08

(52) U.S. Cl. 726/5; 726/3

(57) ABSTRACT

In order to facilitate access to a wireless network, access information (and, more generally, credentials) may be provided to an electronic device via an image. In particular, the electronic device may capture an image that includes a representation of the access information. For example, the electronic device may scan a two-dimensional representation of the access information, such as a Quick Response (QR) code. Then, the electronic device may analyze the image to extract the access information. Next, the access information may be used to access the wireless network. This communication technique allows a user of the electronic device to access the wireless network with less effort, thereby improving the user's experience.

### CROSS REFERENCE TO RELATED APPLICATION

This application claims priority under 35 U.S.C. §119(e) to U.S. Provisional Application Ser. No. 61/697,160, entitled “Wi-Fi Credential Sharing Using Images,” by Artiom Shamis, Kapil Chhabra, and Tito Thomas, Attorney docket number APL-P17025USP1, filed on Sep. 5, 2012, the contents of which is herein incorporated by reference.

### BACKGROUND

1. Field

The described embodiments relate to techniques for sharing information to facilitate access to wireless networks.

2. Related Art

Many electronic devices, such as cellular telephones, include a networking subsystem that is used to wirelessly communicate with other electronic devices. For example, these electronic devices can include a networking subsystem with a cellular-telephone network interface (UMTS, LTE, etc.), a wireless local area network interface (e.g., a wireless network such as described in the Institute of Electrical and Electronics Engineers (IEEE) standards 802.11 or Bluetooth™ from the Bluetooth Special Interests Group of Kirkland, Wash.), and/or other types of wireless interfaces.

In order to access a wireless network, an electronic device typically needs the network name and credentials (such as a passcode). In the case of a cellular-telephone network, this information is usually contained in memory on the electronic device. However, in order to access other wireless networks, a user of the electronic device may have to perform multiple operations.

For example, a coffeehouse may provide a wireless network for its customers. To facilitate access to the wireless network, a customer may be given a wireless-network password on their receipt. Subsequently, in order to join the wireless network, the customer may have to first enable wireless-network access on their electronic device, and then manually enter the password. Performing these operations is time-consuming and cumbersome, which degrades the user experience.

### SUMMARY

The described embodiments relate to an electronic device. This electronic device includes: an antenna; an interface circuit, coupled to the antenna, which communicates with another electronic device; a processor coupled to the interface circuit; and memory that stores a program module that is executed by the processor. The program module facilitates access to a wireless network. In particular, after the electronic device receives an image that includes a representation of access information for the wireless network, the program module extracts the access information from the image. Then, the electronic device accesses the wireless network using the access information.

Note that communication via the wireless network may involve a communication protocol, such as Wi-Fi and/or Bluetooth™.

Moreover, the image may include a two-dimensional representation of the access information, such as a Quick Response (QR) code. This image may be received by performing a scanning operation.

Furthermore, the access information may include: a name of the wireless network, a password (or a passcode) and/or an expiration time for the password.

Additionally, the extracting and accessing occur without action by a user of the electronic device.

Another embodiment provides a method that includes at least some of the operations performed by the electronic device.

Another embodiment provides a computer-program product for use with the electronic device. This computer-program product includes instructions for at least some of the operations performed by the electronic device.

### BRIEF DESCRIPTION OF THE FIGURES

FIG. 1 is a block diagram illustrating electronic devices wirelessly communicating in accordance with an embodiment of the present disclosure.

FIG. 2 is a flow diagram illustrating a method for accessing a wireless network in accordance with an embodiment of the present disclosure.

FIG. 3 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to facilitate access to a wireless network, access information (and, more generally, credentials) may be provided to an electronic device via an image. In particular, the electronic device may capture an image that includes a representation of the access information. For example, the electronic device may scan a two-dimensional representation of the access information, such as a Quick Response (QR) code. Then, the electronic device may analyze the image to extract the access information. Furthermore, the access information may be used to access the wireless network. This communication technique may allow a user of the electronic device to access the wireless network with reduced effort, thereby improving the user experience and customer satisfaction.

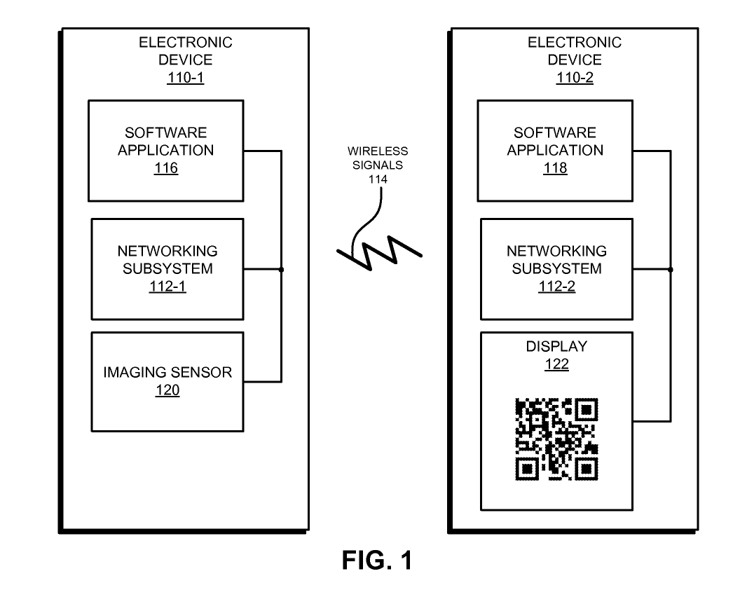

The communication between the electronic devices is shown in FIG. 1, which presents a block diagram illustrating electronic devices 110 which are wirelessly communicating. In particular, these electronic devices may wirelessly communicate while: discovering one another by scanning wireless channels, transmitting and receiving advertising frames on wireless channels, establishing connections (for example, by transmitting connect requests), and/or transmitting and receiving packets (which may include the commands and/or the information as payloads).

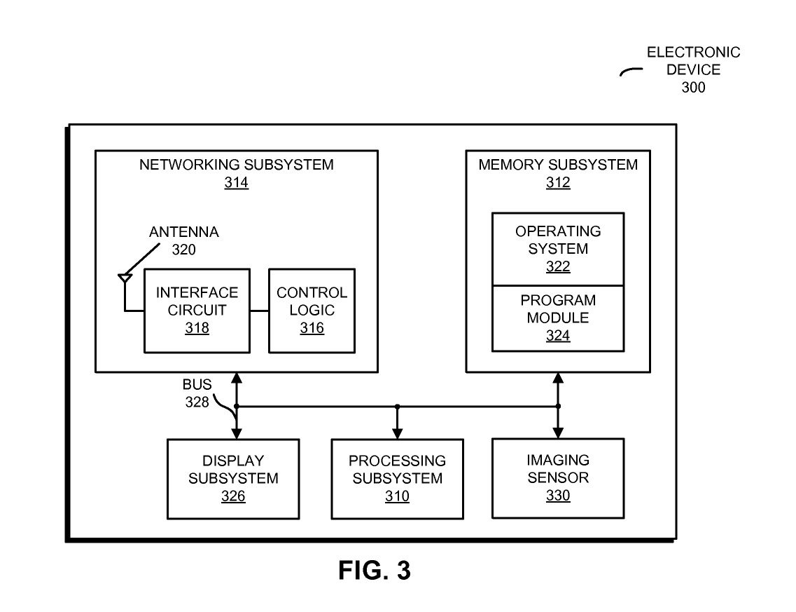

As described further below with reference to FIG. 3, each of electronic devices 110 may include subsystems, such as a networking subsystem, a memory subsystem and a processor subsystem. In addition, electronic devices 110 may include radios in networking subsystems 112. More generally, electronic devices 110 can include (or can be included within) any electronic devices with the networking subsystems that enable electronic devices 110 to wirelessly communicate with another electronic device. This can comprise: transmitting advertising frames on wireless channels to enable electronic devices to make initial contact, followed by exchanging subsequent data/management frames (such as connect requests) to establish a connection; configuring security options (e.g., IPSEC); transmitting and receiving packets or frames via the connection; etc.

As can be seen in FIG. 1, wireless signals 114 (represented by a jagged line) are transmitted from a radio in electronic device 110-1. These wireless signals 114 are received by a radio in electronic device 110-2.

In the described embodiments, processing a packet or frame in either of electronic devices 110-1 and 110-2 includes: receiving wireless signals 114 with the packet or frame; decoding/extracting the packet or frame from received wireless signals 114 to acquire the packet or frame; and processing the packet or frame to determine information contained in the packet or frame (such as the command or the information in the payload).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

In the discussion that follows, a Wi-Fi communication protocol (and, more generally, a communication protocol described in the Institute of Electrical and Electronics Engineers (IEEE) standards 802.11) is used as an illustration of a communication technique used when communicating information between electronic devices 110. However, in other embodiments another type of wireless communication technique is used, such as Bluetooth™ (from the Bluetooth Special Interests Group of Kirkland, Wash.).

In order for one of electronic devices 110 (such as electronic device 110-1) to communicate with the other electronic device (such as electronic device 110-2) using a Wi-Fi communication protocol, a user of electronic device 110-1 typically enables Wi-Fi access, for example, using a user interface on electronic device 110-1. Then, electronic device 110-1 ‘discovers’ electronic device 110-2. Next, electronic device 110-1 provides access information (including a password) for the Wi-Fi wireless network so that a connection or a link can be established between electronic devices 110. However, as noted previously, performing these multiple operations can be time-consuming and frustrating for a user of electronic device 110-1, which can degrade the user experience and, thus, can adversely impact sales of electronic device 110-1 and customer retention.

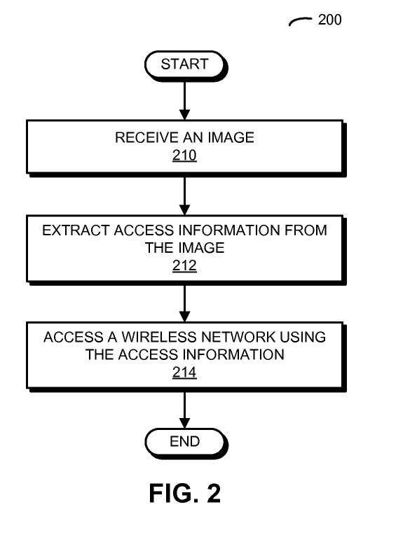

This problem may be addressed using a communication technique in which a software application 116 executing in an environment on electronic device 110-1 receives the necessary access information for the Wi-Fi wireless network via an image (such as that of a QR code on display 122) acquired using imaging sensor 120. The communication technique is shown in FIG. 2, which presents a flow diagram illustrating a method 200 for accessing a wireless network that may be performed by an electronic device (such as electronic device 300 in FIG. 3). During operation, the electronic device receives an image (operation 210) that includes a representation of the access information for the wireless network. For example, the image may be received by performing a scanning operation. Moreover, the image may include a two-dimensional representation of the access information, such as a Quick Response (QR) code.

Then, the electronic device extracts the access information from the image (operation 212). Moreover, the electronic device accesses the wireless network using the access information (operation 214). For example, the access information may include: a name of the wireless network, a password and/or an expiration time for the password. Note that the extracting (operation 212) and the accessing (operation 214) may occur without action by a user of the electronic device.

Therefore, the communication technique may allow the user to access the wireless network quickly and with minimal effort, which may reduce user frustration and improve the user experience. In addition, by using an image to convey the access information, the communication technique may restrict the range over which the access information can be received, thereby improving security.

In some embodiments of method 200, there may be additional or fewer operations. Moreover, the order of the operations may be changed, and/or two or more operations may be combined into a single operation.

Referring back to FIG. 1, in an exemplary embodiment method 200 (FIG. 2) allows a software application (such as software application 116 executing on or in an environment of electronic device 110-1 or software application 118 executing on or in an environment of electronic device 110-2) to receive the access information for a wireless network. For example, the access information may be represented in a QR code (and, more generally, a two-dimensional barcode). A QR code conveys information arranged in a 177×177 matrix, and offers high density and high capacity (e.g., up to 3 KB of data), which can be scanned using a 2 M pixel camera or imaging sensor. In addition, a QR code may include built-in error correction.

For example, after purchasing a beverage at a coffee shop, the user may receive the access information in the form of a QR code printed on their receipt. Alternatively or additionally, the QR code may be printed on a menu. In response, the user may launch software application 116 to capture or scan an image of the QR code using a camera or imaging sensor in their cellular telephone. In some embodiments, the image may be captured by a personal assistant (such as Siri from Apple Inc. of Cupertino, Calif.) in response to a user command to ‘scan.’ Alternatively or additionally, the user may respond to an alert displayed in a window in a user interface, such as in the Notification Center window; and/or the user may activate a scan feature when they enable Wi-Fi access in another window in the user interface.

Then, the cellular telephone may capture the image and may extract the access information from the image. Using the access information, the cellular telephone may access the wireless network. For example, the access information may include the network name or identifier (such as a Service Set Identifier or SSID), a password and a password expiration time. Note that these operations may occur seamlessly and with little or no user action. Thus, in response to receiving the image, the cellular telephone may activate or enable wireless-network access (such as Wi-Fi) and may use the access information to access the network (at least until the password expires). As a consequence, the communication technique may be used to provide an intuitive and seamless user experience.

In other embodiments, an image (such as a QR code) is used to convey the access information between electronic devices. This may allow one electronic device (such as a cellular telephone) to host a personal hotspot for another proximate electronic device (such as a tablet computer or a television). Once again, the access information (including credentials for the wireless network) may be conveyed between the electronic devices by displaying an image on a display in one electronic device, which is subsequently captured or scanned by a camera or an imaging sensor on another electronic device. A similar approach may be used to allow a guest to join a home network or an electronic device to access a wireless network in a vehicle (such as an automobile), e.g., by scanning an image displayed on a display in a navigation system. In addition, a television may display an image that includes a representation of the access information, and a user of an electronic device may capture a picture of this image so that the electronic device can access a wireless network hosted by the television. This may allow the user to access content (such as pictures or files) stored in memory in the television.

Thus, the communication technique may be used to establish a connection in a wireless network. In other embodiments, the connection technique may be used to convey infrastructure information between the electronic devices. Moreover, another application may be to use the image to amass a shopping list. For example, a user may scan a QR code on an empty cereal box, which is then added to the user's shopping list. Alternatively, a QR code may be used to communicate contact information between electronic devices (e.g., an electronic business card).

We now describe embodiments of the electronic device. FIG. 3 presents a block diagram illustrating an electronic device 300. This electronic device includes processing subsystem 310, memory subsystem 312, and networking subsystem 314. Processing subsystem 310 includes one or more devices configured to perform computational operations. For example, processing subsystem 310 can include one or more microprocessors, application-specific integrated circuits (ASICs), microcontrollers, programmable-logic devices, and/or one or more digital signal processors (DSPs).

Memory subsystem 312 includes one or more devices for storing data and/or instructions for processing subsystem 310 and networking subsystem 314. For example, memory subsystem 312 can include dynamic random access memory (DRAM), static random access memory (SRAM), and/or other types of memory. In some embodiments, instructions for processing subsystem 310 in memory subsystem 312 include: one or more program modules or sets of instructions (such as program module 324), which may be executed by processing subsystem 310. Note that the one or more computer programs may constitute a computer-program mechanism. Moreover, instructions in the various modules in memory subsystem 312 may be implemented in: a high-level procedural language, an object-oriented programming language, and/or in an assembly or machine language. Furthermore, the programming language may be compiled or interpreted, e.g., configurable or configured, to be executed by processing subsystem 310. In some embodiments, at least a portion of program module 324 includes an application tool that is embedded in the web page, and which executes in a virtual environment of a web browser. Thus, the application tool may be provided to electronic device 300 via a client-server architecture.

In addition, memory subsystem 312 can include mechanisms for controlling access to the memory. In some embodiments, memory subsystem 312 includes a memory hierarchy that comprises one or more caches coupled to a memory in electronic device 300. In some of these embodiments, one or more of the caches is located in processing subsystem 310.

In some embodiments, memory subsystem 312 is coupled to one or more high-capacity mass-storage devices (not shown). For example, memory subsystem 312 can be coupled to a magnetic or optical drive, a solid-state drive, or another type of mass-storage device. In these embodiments, memory subsystem 312 can be used by electronic device 300 as fast-access storage for often-used data, while the mass-storage device is used to store less frequently used data.

Networking subsystem 314 includes one or more devices configured to couple to and communicate on a wired and/or wireless network (i.e., to perform network operations), including: control logic 316, an interface circuit 318 and an antenna 320. For example, networking subsystem 314 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 300 may use the mechanisms in networking subsystem 314 for performing simple wireless communication between the electronic devices, e.g., transmitting advertising frames and/or scanning for advertising frames transmitted by other electronic devices.

Within electronic device 300, processing subsystem 310, memory subsystem 312, and networking subsystem 314 are coupled together using bus 328. Bus 328 may include an electrical, optical, and/or electro-optical connection that the subsystems can use to communicate commands and data among one another. Although only one bus 328 is shown for clarity, different embodiments can include a different number or configuration of electrical, optical, and/or electro-optical connections between the subsystems.

In some embodiments, electronic device 300 includes a display subsystem 326 for displaying information on a display, which may include a display driver and the display, such as a liquid-crystal display, a touchscreen, etc.

Furthermore, electronic device 300 may include an imaging sensor 330 (such as a camera or a charge-coupled device). Program module 324 may be used in conjunction with imaging sensor 330 to receive access information for a wireless network, such as: a name of the wireless network, a password and an expiration time for the password (e.g., the password may be valid for an hour or a day, or may be valid for one login or session). For example, imaging sensor 330 may be used to capture or scan an image. This image may include a representation of the access information for a wireless network. In some embodiments, the access information is encoded in a two-dimensional spatial pattern in the image (such as in a QR code or a two-dimensional barcode). Then, program module 324 extracts the access information from the image, e.g., by decoding the two-dimensional spatial pattern. Next, program module 324 may provide the access information to networking subsystem 314, so that electronic device 300 can access the wireless network.

Electronic device 300 can be (or can be included in) any electronic device with at least one network interface. For example, electronic device 300 can be (or can be included in): a desktop computer, a laptop computer, a server, a media player (such as an MP3 player), an appliance, a subnotebook/netbook, a tablet computer, a smartphone, a cellular telephone, a piece of testing equipment, a network appliance, a set-top box, a personal digital assistant (PDA), a toy, a controller, a digital signal processor, a game console, a computational engine within an appliance, a consumer-electronic device, a portable computing device, a personal organizer, and/or another electronic device.

Although specific components are used to describe electronic device 300, in alternative embodiments, different components and/or subsystems may be present in electronic device 300. For example, electronic device 300 may include one or more additional instances of imaging sensor 330, processing subsystems 310, memory subsystems 312, networking subsystems 314, and/or display subsystems 326. Additionally, one or more of the subsystems may not be present in electronic device 300. Moreover, in some embodiments, electronic device 300 may include one or more additional subsystems that are not shown in FIG. 3. For example, electronic device 300 can include, but is not limited to: a power subsystem (such as a battery), a data collection subsystem, an audio and/or video subsystem, an alarm subsystem, a media processing subsystem, and/or an input/output (I/O) subsystem. Also, although separate subsystems are shown in FIG. 3, in some embodiments, some or all of a given subsystem or component can be integrated into one or more of the other subsystems or component(s) in electronic device 300. For example, program module 324 may be included in operating system 322.

Moreover, the circuits and components in electronic device 300 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 314, such as a radio. Moreover, the integrated circuit may include hardware and/or software mechanisms that are used for transmitting wireless signals from electronic device 300 and receiving signals at electronic device 300 from other electronic devices. Aside from the mechanisms herein described, radios are generally known in the art and hence are not described in detail. In general, networking subsystem 314 and/or the integrated circuit can include any number of radios. Note that the radios in multiple-radio embodiments function in a similar way to the described single-radio embodiments.

In some embodiments, networking subsystem 314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, etc.)

While Wi-Fi was used as an illustrative example, the described embodiments of the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

Furthermore, while the preceding embodiments used the communication technique to communicate or convey the access information via an image, more generally the image may be used to convey credential information for a restricted resource (e.g., a printer).

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna;
an interface circuit, coupled to the antenna, configured to communicate via a wireless network;
a processor; and
memory, wherein the memory stores a program module, and wherein the program module is configurable to be executed by the processor to facilitate access to the wireless network, the program module including:
instructions for receiving an image that includes a representation of access information for the wireless network;
instructions for extracting the access information from the image; and
instructions for accessing the wireless network using the access information.

2. The electronic device of claim 1, wherein communication via the wireless network involves a communication protocol; and
wherein the communication protocol includes Wi-Fi.

3. The electronic device of claim 1, wherein communication via the wireless network involves a communication protocol; and
wherein the communication protocol includes Bluetooth™.

4. The electronic device of claim 1, wherein the image includes a two-dimensional representation of the access information.

5. The electronic device of claim 1, wherein receiving the image involves performing a scanning operation.

6. The electronic device of claim 1, wherein the access information includes a name of the wireless network, a password and an expiration time for the password.

7. The electronic device of claim 1, wherein the extracting and accessing occur without action by a user of the electronic device.

8. A computer-program product for use in conjunction with an electronic device, the computer-program product comprising a non-transitory computer-readable storage medium and a computer-program mechanism embedded therein, to facilitate access to a wireless network, the computer-program mechanism including:
instructions for receiving an image that includes a representation of access information for the wireless network;
instructions for extracting the access information from the image; and
instructions for accessing the wireless network using the access information.

9. The computer-program product of claim 8, wherein communication via the wireless network involves a communication protocol; and
wherein the communication protocol includes Wi-Fi.

10. The computer-program product of claim 8, wherein communication via the wireless network involves a communication protocol; and
wherein the communication protocol includes Bluetooth™.

11. The computer-program product of claim 8, wherein the image includes a two-dimensional representation of the access information.

12. The computer-program product of claim 8, wherein receiving the image involves performing a scanning operation.

13. The computer-program product of claim 8, wherein the access information includes a name of the wireless network, a password and an expiration time for the password.

14. The computer-program product of claim 8, wherein the extracting and accessing occur without action by a user of the electronic device.

15. An electronic-device-implemented method for accessing a wireless network, wherein the method comprises:
receiving an image that includes a representation of access information for the wireless network;
using the electronic device, extracting the access information from the image; and
accessing the wireless network using the access information.

16. The method of claim 15, wherein communication via the wireless network involves a communication protocol; and
wherein the communication protocol includes Wi-Fi.

17. The method of claim 15, wherein communication via the wireless network involves a communication protocol; and
wherein the communication protocol includes Bluetooth™.

18. The method of claim 15, wherein the image includes a two-dimensional representation of the access information.

19. The method of claim 15, wherein receiving the image involves performing a scanning operation.

20. The method of claim 15, wherein the access information includes a name of the wireless network, a password and an expiration time for the password.

21. The method of claim 15, wherein the extracting and accessing operations occur without action by a user of the electronic device.
